(19) United States
(12) Patent Application Publication
(10) Pub. No.: US 2008/0080446 A1
(43) Pub. Date: Apr. 3, 2008

(54) SYSTEMS AND METHODS FOR POWER MANAGEMENT IN A MULTIPLE INPUT MULTIPLE OUTPUT (MIMO) WIRELESS LOCAL AREA NETWORK (WLAN)

(75) Inventor: ChingAn Chung, Miaoli County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/536,174

(22) Filed: Sep. 28, 2006

(51) Int. Cl. H04B 7/216

(52) U.S. Cl. 370/342

(57) ABSTRACT

Methods for power management in a multiple input multiple output (MIMO) wireless local area network (WLAN). The methods are performed by a wireless station. The wireless station comprises multiple initially powered down radio frequency chains. An embodiment of a power management method comprises the following steps. At least one quality magnitude is generated in response to at least one previous listening result. One or more radio frequency (RF) chains are powered on to listen for a new synchronization frame according to the generated quality magnitude upon reaching a specific wake-up time.

### BACKGROUND

The invention relates to power management, and more particularly, to systems and methods for power management in a multiple input multiple output (MIMO) wireless communication, such as wireless local area network (WLAN).

Charge storage devices, such as batteries, typically provide power for wireless stations, such as mobile phones, handheld devices and others. The battery is generally rechargeable and made of alkaline batteries in the form of an enclosure type nickel cadmium (Ni—Cd) battery or nickel metal hydride (Ni-MH) battery. Also, lithium ion (Li-ion) batteries of an organic electrolytic cell have been used in high-end wireless stations. Battery powered wireless stations typically require reduced power consumption for extended connection time.

### SUMMARY

Methods for power management in a multiple input multiple output (MIMO) wireless communication, such as wireless local area network (WLAN) performed by a wireless station, are provided. The wireless station comprises multiple initially powered down radio frequency chains. An embodiment of a power management method comprises the following steps. At least one quality magnitude is generated in response to at least one previous listening result. One or more radio frequency (RF) chains are powered on to listen to a new synchronization frame according to the generated quality magnitude upon reaching a specific wake-up time. This synchronization frame can be received by one or more RF chains. In MIMO WLAN, it is beacon.

Systems for power management in a MIMO WLAN are also provided for explanation. An embodiment of a power management system comprises multiple RF chains and a processing unit. The processing unit coupled to the RF chains generates at least one quality magnitude in response to at least one previous listening result, and powers on one or more RF chains to listen to a new synchronization frame according to the generated quality magnitude upon reaching a specific wake-up time.

### BRIEF DESCRIPTION OF THE DRAWINGS

The invention can be more fully understood by reading the subsequent detailed description and examples with references made to the accompanying drawings, wherein:

FIG. 1 is a diagram of an embodiment of a multiple input multiple output (MIMO) wireless local area network;

FIGS. 2a and 2b are timing diagrams illustrating power consumption when stations sleep and awake for listening to beacons;

FIGS. 3 to 5 are flowcharts illustrating embodiments of power management methods;

FIG. 6a is a diagram of a legacy frame body format of a management frame of a beacon;

FIG. 6b is legacy TIM (traffic indication message) element format in beacon.

### DETAILED DESCRIPTION

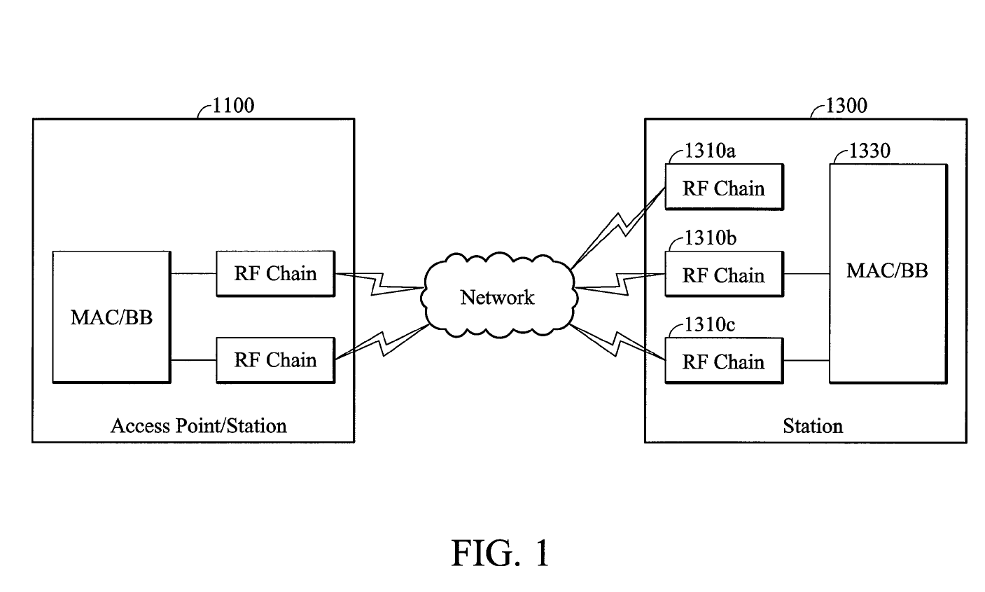

Wireless stations, such as mobile phones, notebooks, game consoles and similar, can utilize multiple transmitters and receivers (multiple antennas) to improve performance. When two transmitters and two or more receivers are used, two simultaneous data streams, doubling the data rate can be transmitted. Multiple receivers alone allow communication of greater distance between wireless stations as it has better error robustness. FIG. 1 is a diagram of an embodiment of a multiple input multiple output (MIMO) wireless local area network (WLAN), comprising an access point (AP) or a wireless station 1100, and a wireless station 1300. The wireless station 1300 comprises three radio frequency (RF) chains 1310a to 1310c respectively comprising a transmitter (Tx) and a receiver (Rx). A processing unit disposed on a media access control (MAC)/baseband (BB) 1330 can selectively power one or more RF chains on or off via various control interfaces, thereby enabling the powered RF chains to transmit or receive synchronization frames, data streams or others. The synchronization frame (beacon in WLAN) synchronizes connection between the AP/wireless station 1100 and wireless station 1300, and can be listened to by either a single RF chain or multiple RF chains.

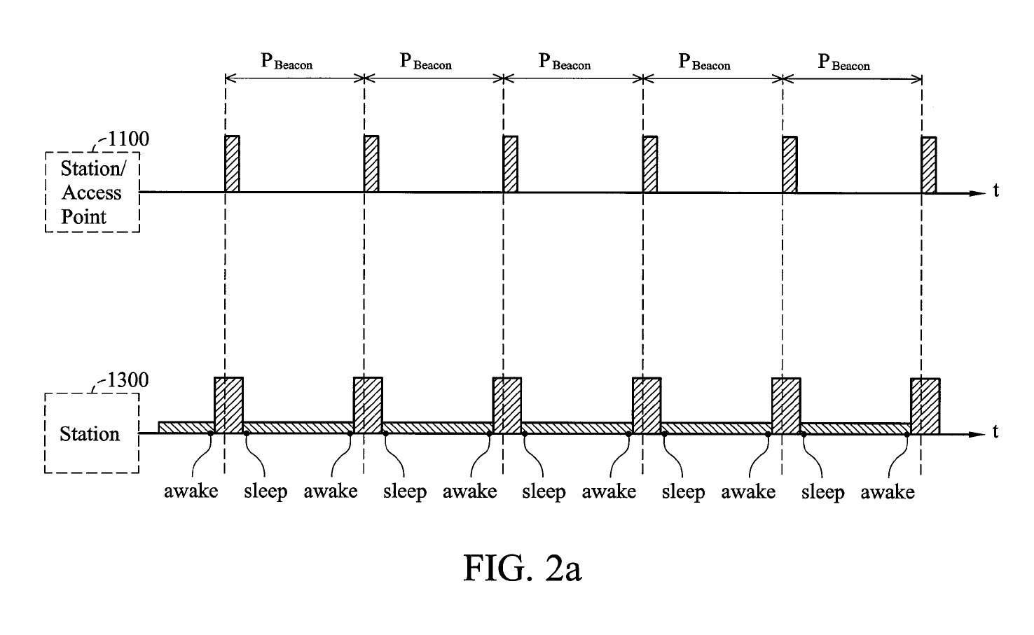

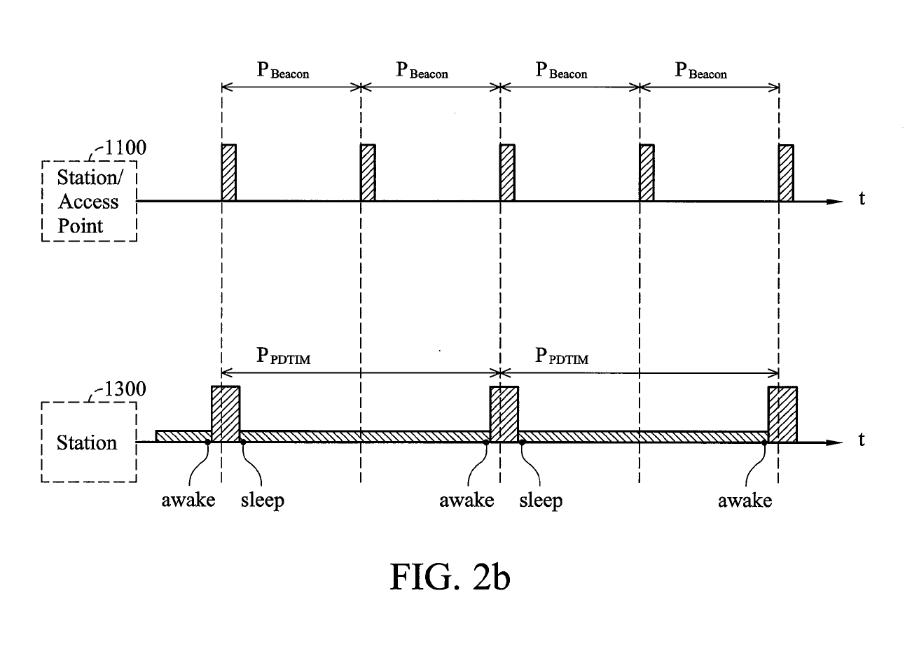

For example, the network may operate in an infrastructure mode or an ad-hoc mode. When operating in infrastructure mode, the access point 1100 operating as a central base station send synchronization frames, such as beacons, broadcast and unicast messages to station 1300 and the other connected stations. When operating in ad-hoc mode (i.e. a peer-to-peer wireless network), the stations 1100 and 1300 communicate directly with each other rather than through an intermediary central base station. Beacons sent by the stations 1100 and 1300 compete for transmission priority. Beacons are packets sent by the access point 1100 to synchronize a wireless network. FIG. 2a is a timing diagram illustrating power consumption when the station 1300 sleeps and awakes for listening to beacons. The station/access point 1100 periodically sends beacons to the station 1300. A beacon is transmitted after a predetermined beacon interval P_{Beacon}. The station 1300 wakes up to listen for a beacon during the predetermined beacon interval P_{Beacon} between transmitted beacons, and sleeps to reduce power consumption when acquiring information indicating that the access point or station 1100 will send no broadcast, multicast or unicast message to the station 1300 from the listened for beacon. A timing synchronization function (TSF) based on the 802.11 power saving definition may be contained in a beacon to inform the station 1300 of the next window for listening to broadcast and unicast messages. FIG. 2b is a timing diagram illustrating power consumption when the station 1300 sleeps and awakes for listening to beacons. In a DTIM (delivery traffic indication message), beacons sent by the station or access point 1100 further contain a DTIM interval value, preferably an integer. The station 1300 wakes up to listen for a beacon during a DTIM interval P_{DTIM}. The DTIM interval corresponds to the DTIM interval value acquired from the last beacon. For example, when receiving a DTIM interval value of two, the station 1300 will wake up to listen for a beacon during a DTIM interval P_{DTIM} between two beacon interval. While the station 1300 sleeps, the RF chains, such as 1310a to 1310c, oscillator and phase locked loop (PLL) thereof are powered down, and only a slow clock, typically of 32K, is used for countdown to wakeup, resulting in consumption of about several micro-amperes (uA) of battery power. When listening to a beacon, the station 1300 consumes excessive power, typically several mini-amperes (mA).

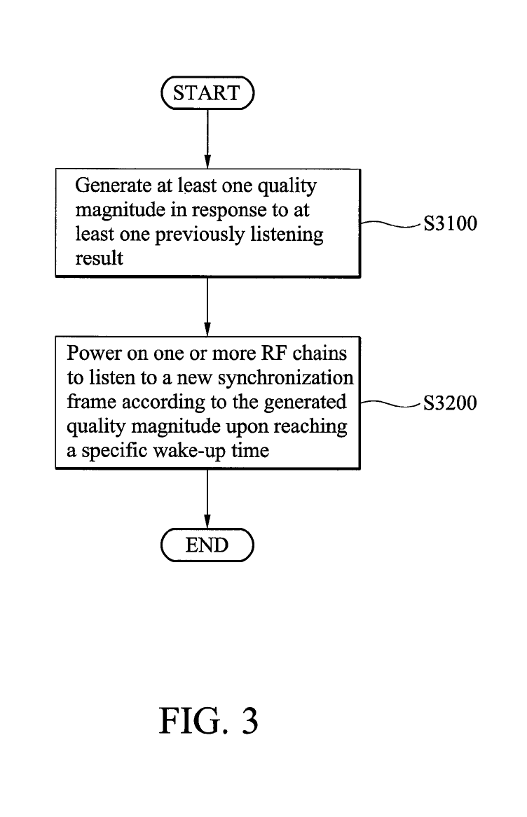

FIG. 3 is a flowchart illustrating an embodiment of a power management method, performed by a wireless station (e.g. 1300 of FIG. 1) comprising multiple initially powered down RF chains (e.g. 1310a to 1310c of FIG. 1). In step S3100, at least one quality magnitude is generated in response to at least one previous listening result. The quality magnitudes may comprise a lost synchronization frame count indicating a number of synchronization frames, such as beacons, have been lost within a detection period, and/or an average RSSI (received signal strength indicator) of the previously received synchronization frames. In step S3200, one or more RF chains are powered on to listen for a new synchronization frame according to the generated quality magnitude upon reaching a specific wake-up time. For example, one RF chain is powered on when the generated quality magnitude indicates good quality, and at least two RF chains are powered on when the generated quality magnitude indicates bad quality. In an example, all RF chains are powered on when the lost synchronization frame count exceeds a predetermined value. In another example, one RF chain is powered on when the lost synchronization frame count is less than or equal to a predetermined value or/and the average RSSI of the previously received synchronization frames is greater than a predetermined level, and more than two RF chains are powered on when the lost synchronization frame count is greater than or equal to the predetermined value or/and the average RSSI of the previously received synchronization frames is less than or equal to the predetermined level. In yet another example, one RF chain is powered on when the average RSSI of the previously received synchronization frames is greater than a predetermined high level, two RF chains are powered on when the average of RSSI of the previously received synchronization frames is between the predetermined high level and a predetermined low level, and at least three RF chains are powered on when the average RSSI of the previously received synchronization frames is less than the predetermined low level.

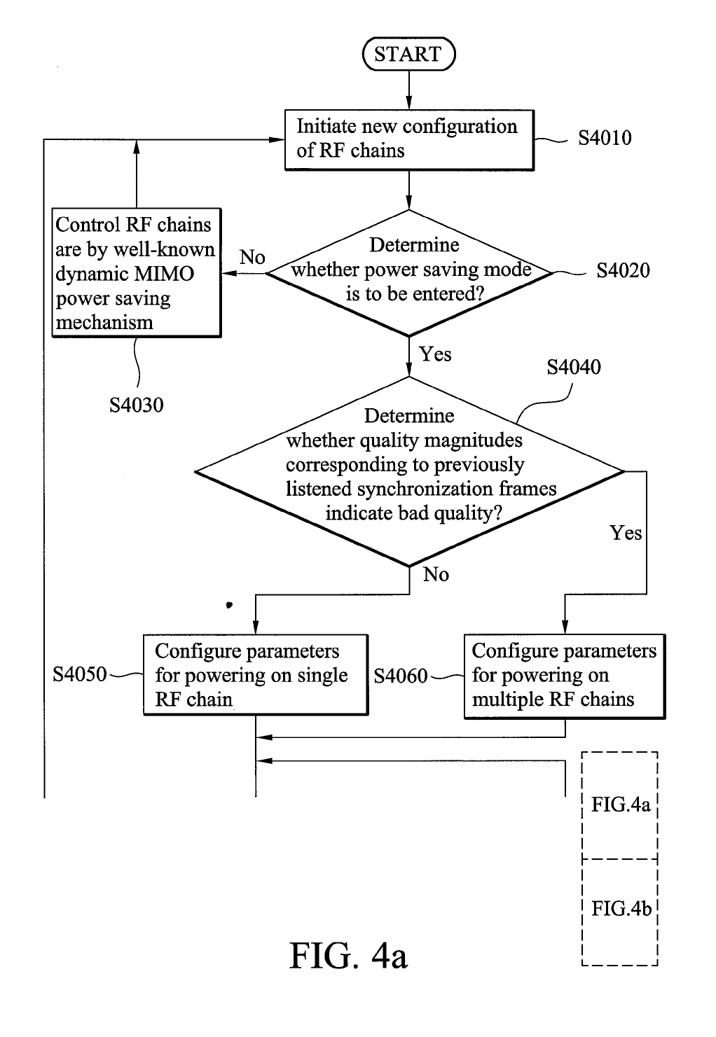

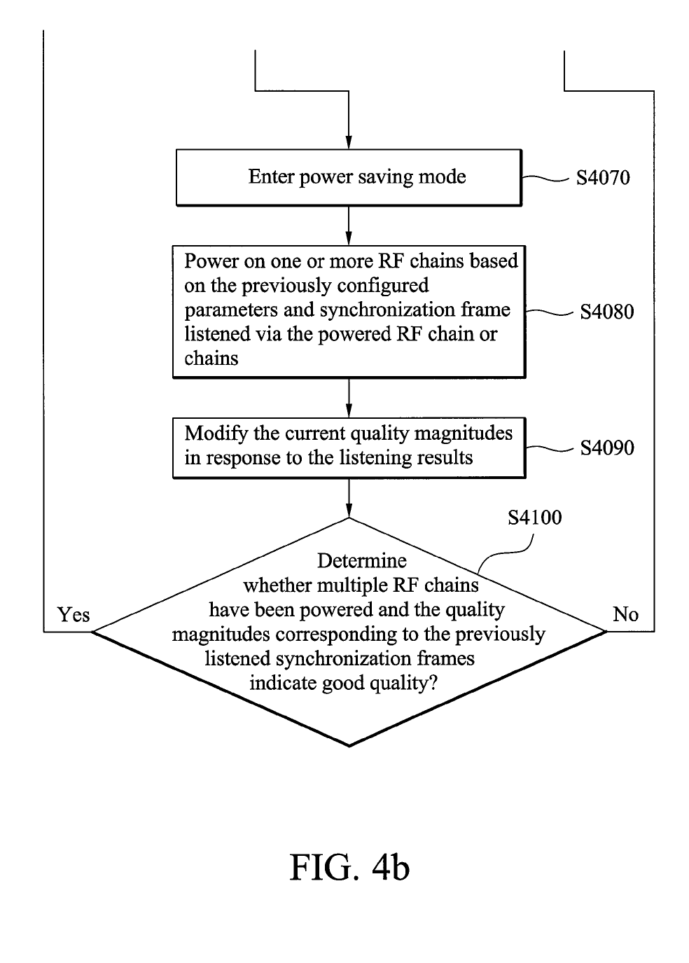

FIG. 4 is a flowchart illustrating an embodiment of a power management method, performed by a processing unit of a MAC/BB (e.g. 1330 of FIG. 1). The flowchart describes a loop containing steps S4010 to S4100 to dynamically and repeatedly power one or more RF chains on or off according to quality magnitudes in response to the previously received synchronization frame when listening for a new synchronization frame, such as a new beacon. Specifically, only one RF chain is powered on upon detecting a good quality magnitude, in order to reduce power consumption, alternatively, upon detecting poor quality magnitudes, more RF chains are powered on in order to improve signal-to-noise ratio (SNR) or extend connection range.

In step S4010, a new configuration of RF chains is initiated. In step S4020, it is determined whether a power saving mode is to be entered. If so, the process proceeds to step S4040, otherwise, to step S4030. For example, it is determined that a power saving mode is not to be entered when transmission of certain messages to a connected access point or wireless station (e.g. 1100 of FIG. 1), is required. Likewise, a power saving mode is not entered when it is detected that the previously received synchronization frame comprised information indicating that certain broadcast or unicast messages are to be received later, or upon detecting that the previously broadcast or unicast message comprised information indicating that at least one message is to be received later. In step S4030, RF chains are controlled by a well-known dynamic MIMO power saving mechanism. The details of the dynamic MIMO power saving mechanism are available in the “802.11n D1.0 Draft Amendment to STANDARD FOR Information Technology—Telecommunications and information exchange between systems-Local and Metropolitan networks-Specific requirements-Part 11: Wireless LAN Medium Access Control (MAC) and Physical Layer (PHY) specifications: Enhancements for Higher Throughput” established March 2006, thus, only brief description thereof is provided.

In step S4040, it is determined whether quality magnitudes corresponding to previously received synchronization frames indicate bad quality. If so, the process proceeds to step S4060, otherwise, to step S4050. In step S4050, parameters for powering on a single RF chain (e.g. one of 1310a to 1310c) are configured upon detecting that the quality magnitudes indicate good quality. In step S4060, parameters for powering up multiple RF chains (e.g. at least two of 1310a to 1310c) are configured upon detecting that the quality magnitudes indicate bad quality. Note that the configured parameters comprise settings of RF channel and RF parameters. In step S4070, a power saving mode is entered. When entering the power saving mode, the oscillator, PLL and all RF chains (e.g. 1310a to 1310c) are preferably powered down to reduce power consumption. In step S4080, upon reaching a wake-up time (as shown in FIGS. 2a and 2b), one or more RF chains are powered based on the previously configured parameters and a synchronization frame is listened for via the powered RF chain or chains. In step S4090, the current quality magnitudes are modified in response to the listening results. In step S4100, it is determined whether multiple RF chains have been powered and the quality magnitudes corresponding to the previously received synchronization frames indicate good quality. If so, the process proceeds to step S4010, otherwise, to step S4070. In step S4010, it will wait synchronization frames to adjust RF chain numbers.

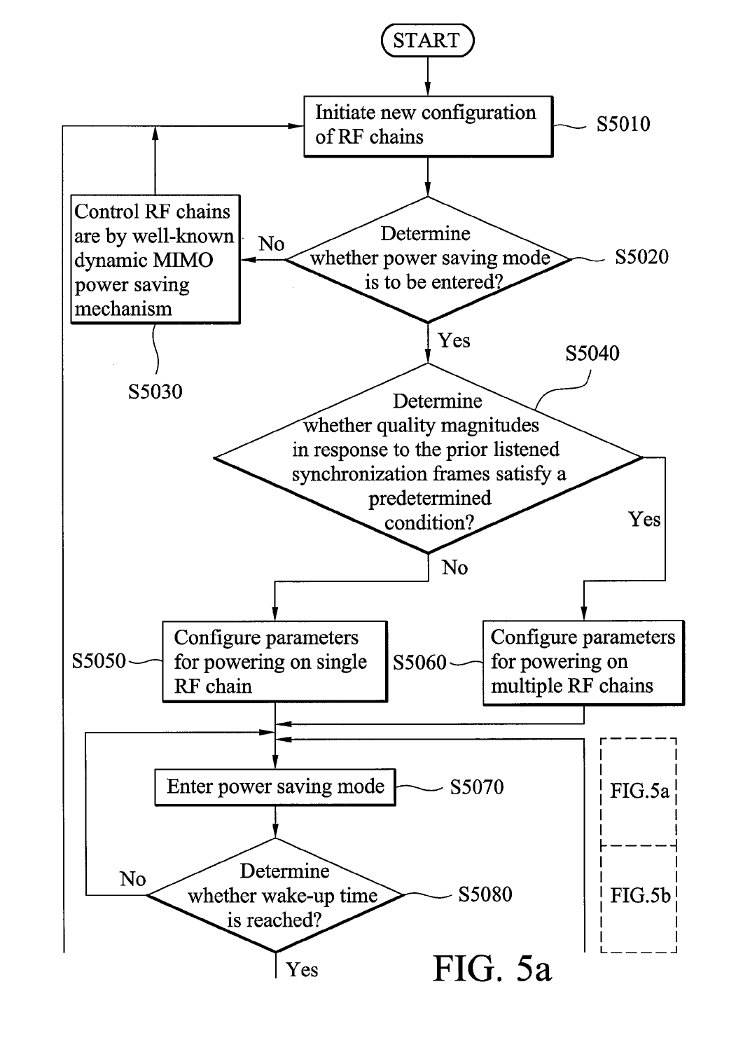

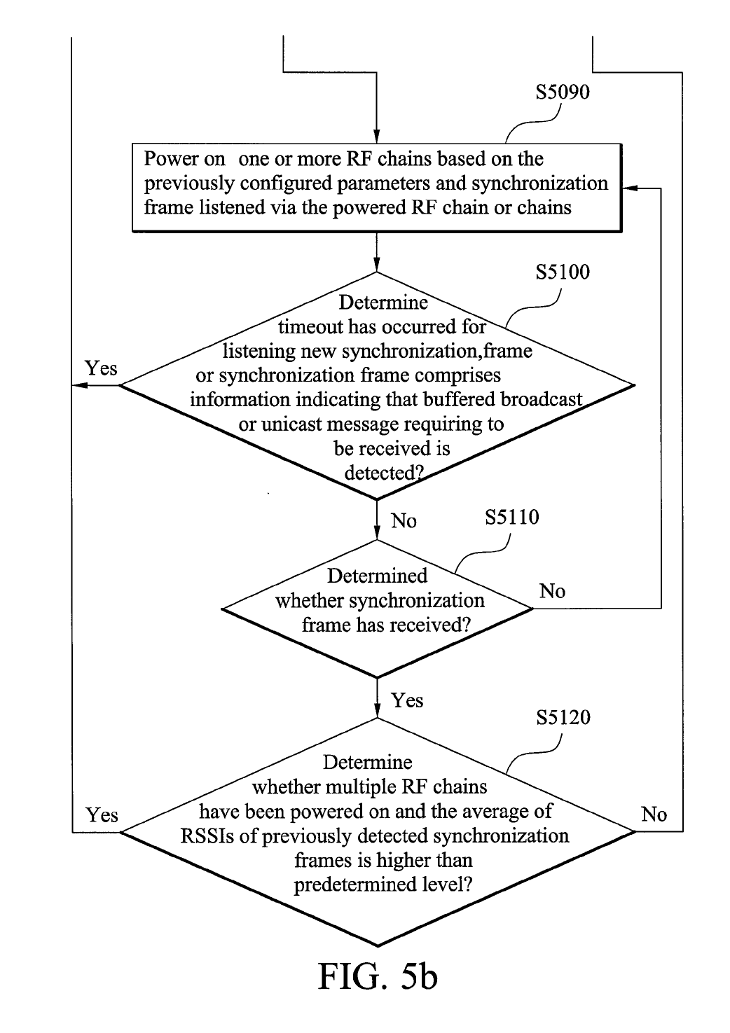

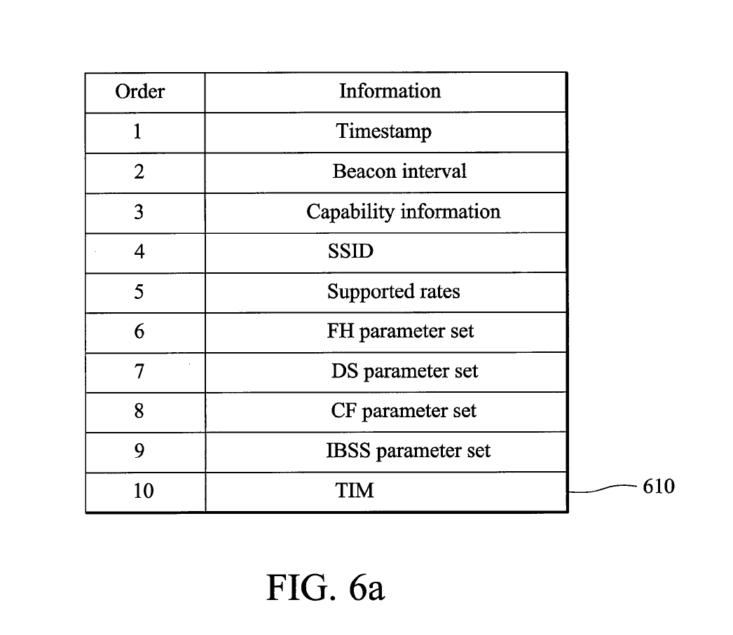

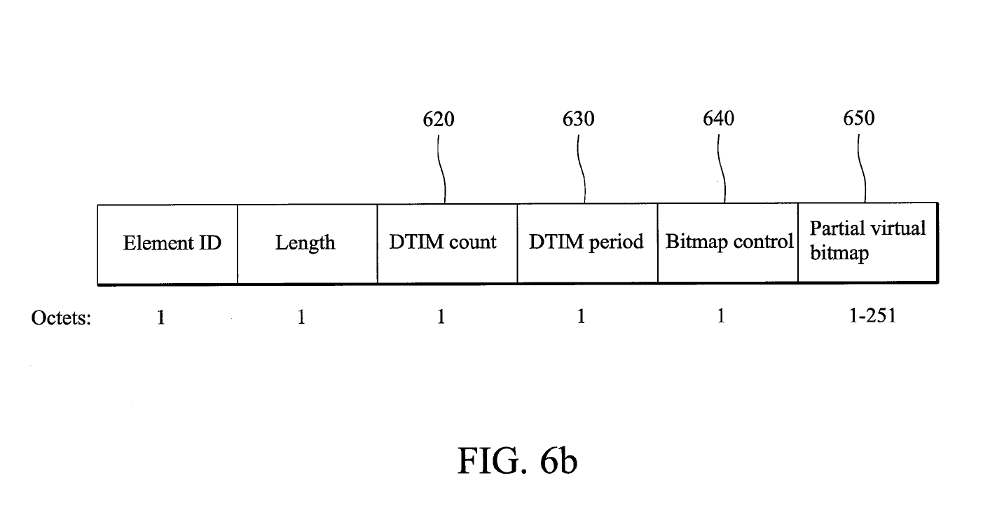

FIG. 5 is a flowchart illustrating an embodiment of a power management method, performed by a processing unit of a MAC/BB (e.g. 1330 of FIG. 1). In step S5010, a new configuration of RF chains is initiated. In step S5020, it is determined whether a power saving mode is to be entered. If so, the proceeds to step S5040, otherwise, to step S5030. For example, it is determined that a power saving mode is not to be entered when transmission of certain messages to a connected access point or wireless station (e.g. 1100 of FIG. 1) is required, or upon detecting the previously received synchronization frame, such as the prior beacon, comprised information indicating that certain broadcast or unicast messages are to be received later, or upon detecting the prior received broadcast or unicast message comprised information indicating that at least one message is to be received later. Broadcast messages buffered in an access point (e.g. 1100 of FIG. 1) are messages ready to sent to multiple wireless stations, and unicast messages buffered in an access point or a wireless station (e.g. 1100 of FIG. 1) are messages ready to sent to a single wireless station. FIG. 6a is a diagram of a legacy frame body format of a management frame of a beacon set forth by the “ANSI/IEEE Std 802.11 Information Technology—Telecommunications and information exchange between systems-Local and Metropolitan networks-Specific requirements-Part 11: Wireless LAN Medium Access Control (MAC) and Physical Layer (PHY) specifications” established 1999, comprising TIM (traffic indication message) element 610. FIG. 6b is a diagram of a legacy TIM element format comprising four fields: DTIM count 620, DTIM period 630, bitmap control 640 and partial virtual bitmap 650. The DTIM count field 620 indicates how many beacons (including the current beacon) are to appear before the next DTIM. The DTIM period field 630 indicates the number of beacon intervals between successive DTIMs. If all TIMs are DTIMs, the DTIM period field 630 has a value of one. The DTIM period field 630 is a single octet. The bitmap control field 640 is a single octet. Information indicating whether at least one buffered broadcast message is ready for transmission to this wireless station is stored in the bitmap control field 640. Information indicating whether at least one buffered unicast message is ready for transmission to this wireless station is stored in the partial virtual bitmap field 650. The bitmap control field 640 is a single octet. Bit 0 of the field contains a traffic indicator. This bit is set to 1 in TIM elements with a value of 0 in the DTIM count field 620 when one or more broadcast messages are buffered at an access point (e.g. 1100 of FIG. 1). A traffic-indication virtual bitmap in the partial virtual bitmap field 650, maintained by an access point generating a TIM, consists of 2008 bits. Each bit in the traffic-indication virtual bitmap corresponds to traffic for a specific wireless station. If any unicast messages are buffered and the access point is prepared to deliver them, number of bits N in the traffic-indication virtual bitmap is 1. In step S5030, RF chains are controlled by a well-known dynamic MIMO power saving mechanism. The details of the dynamic MIMO power saving mechanism are provided in “802.11n D1.0 Draft Amendment to STANDARD FOR Information Technology-Telecommunications and information exchange between systems-Local and Metropolitan networks-Specific requirements-Part 11: Wireless LAN Medium Access Control (MAC) and Physical Layer (PHY) specifications: Enhancements for Higher Throughput” established March 2006, thus, only a brief description thereof is provided.

Step S5040 determines whether quality magnitudes in response to the previously received synchronization frames satisfy a predetermined condition. Specifically, it is determined whether an average RSSI (received signal strength indicator) of previously detected synchronization frames is less than a predetermined level, or a count of lost synchronization frames exceeds a predetermined number within a detection period. If so, the process proceeds to step S5060, otherwise, to step S5050. In step S5050, parameters for powering on a single RF chain (e.g. one of 1310a to 1310c) are configured and the count of lost synchronization frames are cleared (e.g. set to zero) upon detecting that the quality magnitude satisfies the predetermined condition. In step S5060, parameters for powering on multiple RF chains (e.g. at least two of 1310a to 1310c) are configured and the count of lost synchronization frames are cleared (e.g. set to zero) upon detecting that the quality magnitude dissatisfies the predetermined condition. Note that the configured parameters comprise settings of RF channel and RF parameters. Exemplary rules are provided in the following for configuring parameters under a synchronization frame interval of 100 ms and a synchronization frame rate of 1 Mbps:
(1) all RF chains (e.g. 1310a to 1310c of FIG. 1) are powered on when the count of lost synchronization frames exceeds a predetermined number (e.g. 3) within a detection period (e.g. one second);
(2) one RF chain (e.g. 1310a) is powered on when the count of lost synchronization frames does not exceed a predetermined number (e.g. 3) within a detection period (e.g. one second) and the average RSSI of previously detected synchronization frames is greater than a high level (e.g. −74 dbm);
(3) two RF chains (e.g. 1310a and 1310b) are powered on when the count of lost synchronization frames does not exceed a predetermined number (e.g. 3) within a detection period (e.g. one second) and the average RSSI of previously detected synchronization frames is between a high level (e.g. −74 dbm) and a low level (e.g. −77 dbm); and
(4) all RF chains (e.g. 1310a to 1310c of FIG. 1) are powered on when the count of lost synchronization frames does not exceed a predetermined number (e.g. 3) within a detection period (e.g. one second) and the average RSSI of previously detected synchronization frames is less than a low level (e.g. −77 dbm).

A sub-loop containing steps 5070 and 5080 is periodically performed to enter a listen mode to listen for a synchronization frame upon reaching a wake-up time (as shown in FIG. 2a or 2b). Specifically, in step S5070, a power saving mode is entered. When entering the power saving mode, oscillator, PLL and all RF chains (e.g. 1310a to 1310c) are preferably powered down to reduce power consumption. In step S5080, it is determined whether a wake-up time is reached. If so, the process proceeds to step S5090 to exit the power saving mode and enter a listening mode, otherwise, to step S5070 to stay in the power saving mode. In step S5090, when entering the listening mode, one or more RF chains are powered based on the previously configured parameters and a synchronization frames is listened for via the powered RF chain or chains.

In step S5100, it is determined that a new synchronization frame listening session has timed out, or a synchronization frame comprising information indicating that buffered broadcast or unicast message to be received is detected. If so, the process proceeds to step S5010, otherwise, to step S5110. Note that, upon determining that a new synchronization frame listening session has timed out, the count of lost synchronization frames is increased by one. In step S5110, it is determined whether a synchronization frame has been received. If so, the process proceeds to step S5120, otherwise, to step S5090. In step S5120, it is determined whether multiple RF chains have been powered on and the average RSSI of previously detected synchronization frames is higher than a predetermined level (e.g. −74 dbm). If so, the process proceeds to step S5010, otherwise, to step S5070. In step S5010, it will wait synchronization frames to adjust RF chain numbers.

Methods for power management in MIMO WLAN, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD recorder or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for power management in a multiple input multiple output (MIMO) wireless communication, performed by a wireless station comprising a plurality of initially powered down radio frequency (RF) chains, comprising:
generating a quality magnitude in response to a previous listening result; and
powering on one or more radio frequency (RF) chains to listen to a new synchronization frame according to the generated quality magnitude upon reaching a specific wake-up time.

2. The method as claimed in claim 1 wherein the new synchronization frame can be received by one or more RF chains and it is generated periodically.

3. The method as claimed in claim 1 wherein the power on step further comprises:
powering on one RF chain to listen for the new synchronization frame when the generated quality magnitude indicates good quality; and
powering on at least two RF chains to listen for the new synchronization frame when the generated quality magnitude indicates bad quality.

4. The method as claimed in claim 1 wherein the quality magnitude comprises a lost synchronization frame count indicating the number of synchronization frames lost within a detection period, and the power on step further comprises powering on all RF chains when the lost synchronization frame count exceeds a predetermined value.

5. The method as claimed in claim 1 wherein the quality magnitudes comprise an average RSSI (received signal strength indicator) of the previously received synchronization frames, and the power on step further comprises:
powering on one RF chain when the average RSSI of the previously received synchronization frames is greater than a predetermined level; and
powering on more than two RF chains when the average RSSI of the previously received synchronization frames is less than or equal to the predetermined level.

6. The method as claimed in claim 4 wherein the quality magnitudes further comprise an average RSSI of the previously received synchronization frames, the power on step further comprises:
powering on one RF chain when the lost synchronization frame count is less than or equal to the predetermined value, and the average RSSI of the previously received synchronization frames is greater than a predetermined high level;
powering on two RF chains when the lost synchronization frame count is less than or equal to the predetermined value, and the average RSSI of the previously received synchronization frames is between the predetermined high level and a predetermined low level; and
powering on at least three RF chains when the lost synchronization frame count is less than or equal to the predetermined value, and the average RSSI of the previously received synchronization frames is less than the predetermined low level,
and the predetermined high level is greater than the predetermined low level.

7. The method as claimed in claim 1 wherein the new synchronization frame will be transmitted from another wireless station or access point, and the quality magnitude indicates connection quality there between.

8. The method as claimed in claim 1 wherein one or more RF chains comprises receivers (Rx) capable of listening to the new synchronization frame.

9. A system for power management in a multiple input multiple output (MIMO) wireless communication, comprising:
a plurality of radio frequency (RF) chains; and
a processing unit, coupling to the RF chains, generating a quality magnitude in response to a previous listening result, and powering on one or more radio frequency (RF) chains to listen for a new synchronization frame according to the generated quality magnitude upon reaching a specific wake-up time.

10. The system as claimed in claim 9 wherein the new synchronization frame is a new beacon in WLAN.

11. The system as claimed in claim 9 wherein the processing unit further powers on one RF chain to listen for the new synchronization frame when the generated quality magnitude indicates good quality, and powers on at least two RF chains to listen to the new synchronization frame when the generated quality magnitude indicates bad quality.

12. The system as claimed in claim 9 wherein the quality magnitude comprises a lost synchronization frame count indicating the number of synchronization frames lost within a detection period and the processing unit further powers on all RF chains when the lost synchronization frame count exceeds a predetermined value.

13. The system as claimed in claim 9 wherein the quality magnitudes comprise an average RSSI of the previously received synchronization frames, the processing unit powers one RF chain when the average RSSI of the previously received synchronization frames is greater than a predetermined level, and the processing unit powers more than two RF chains when the average RSSI of the previously received synchronization frames is less than or equal to the predetermined level.

14. The system as claimed in claim 12 wherein the quality magnitudes further comprise an average RSSI of the previously received synchronization frames, the processing unit powers one RF chain when the lost synchronization frame count is less than or equal to the predetermined value and the average RSSI of the previously received synchronization frames is greater than a predetermined high level, the processing unit powers two RF chains when the lost synchronization frame count is less than or equal to the predetermined value and the average RSSI of the previously received synchronization frames is between the predetermined high level and a predetermined low level, the processing unit powers on more than three RF chains when the lost synchronization frame count is less than or equal to the predetermined value and the average RSSI of the previously received synchronization frames is less than the predetermined low level, and the predetermined high level is greater than the predetermined low level.

15. The system as claimed in claim 9 wherein the new synchronization frame will be transmitted from another wireless station or access point, and the quality magnitude indicates connection quality there between.

16. The system as claimed in claim 9 wherein one or more RF chain comprises receivers (Rx) capable of listening to the new synchronization frame.
